(19) United States
(12) Patent Application Publication
(10) Pub. No.: US 2011/0013938 A1
(43) Pub. Date: Jan. 20, 2011

(54) CHARGING DEVICE, IMAGE FORMING APPARATUS, AND METHOD OF MAINTAINING GAP BETWEEN CHARGING ROLLER AND PHOTOCONDUCTIVE DRUM

(75) Inventor: Chie Tonohiro, Shizuoka (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/833,179

(22) Filed: Jul. 9, 2010

Related U.S. Application Data
(60) Provisional application No. 61/226,863, filed on Jul. 20, 2009.

(51) Int. Cl. G03G 15/02

(52) U.S. Cl. 399/168

(57) ABSTRACT

According to one embodiment, a charging device includes a charging roller and gap maintaining members. The charging roller includes a conductive roller to which charging voltage is applied and a coating layer as a member for covering the outer circumferential surface of the conductive roller, ends of the coating layer being further extended by predetermined length along an extending direction of the conductive roller than end faces of the conductive roller. The charging roller charges, in a non-contact manner, a photoconductive drum arranged near the charging roller with the charging voltage applied via the conductive roller. The gap maintaining members are respectively fixed at both ends of the charging roller in positions spaced apart from the ends of the charging roller. The gap maintaining members are set in contact with the photoconductive drum while keeping a predetermined charging gap between the coating layer and the photoconductive drum and rotate together with the charging roller according to the rotation of the photoconductive drum.

### CROSS-REFERENCE TO RELATED APPLICATION

This application is based upon and claims the benefit of priority from Provisional U.S. Application No. 61/226,863, filed on 20th Jul., 2009, the entire contents of which are incorporated herein by reference.

### FIELD

Embodiments described herein relate generally to a charging device, an image forming apparatus including the charging device, and a method of maintaining a gap between a charging roller and a photoconductive drum.

### BACKGROUND

In recent years, as a technique for an image forming apparatus, there is proposed an image forming apparatus including a charging device configured to charge a photoconductive drum as an image bearing member in a non-contact manner with a predetermined gap set between the charging roller and the photoconductive drum.

In the charging device used in such an image forming apparatus, the outer circumferential surface of a charging roller made of metal opposed to an image forming area of the photoconductive drum is covered with a coating layer (a charging tube) having conductivity. Gap maintaining members are fixed at both ends of the charging roller. The gap maintaining members are set in contact with the outer circumferential surface of the photoconductive drum, whereby a predetermined very small charging gap is maintained between the gap maintaining members and the photoconductive drum. When bearings of shaft sections formed to project in an axis direction from both end faces of the charging roller are pressed toward the photoconductive drum with urging force of compression springs and the charging roller rotates according to the rotation of the photoconductive drum, the photoconductive drum is charged in a non-contact manner via the charging gap.

However, in order to set the gap maintaining members at both the ends of the charging roller, the positions of ends of the coating layer need to coincide with the positions of the ends of the charging roller. Specifically, in a coating method in the past, if the ends of the coating layer are further on the inner side than the ends of the charging roller, it is likely that high voltage leaks from an exposed metal shaft to the photoconductive drum side. Conversely, if the ends of the coating layer reach the outer side of the ends of the charging roller and the coating layer is molded to be bent in front of the gap maintaining members, it is likely that bent sections project or recess, a proper gap between the charging roller and the photoconductive drum cannot be maintained, and abnormal discharge and charging unevenness are caused.

### BRIEF DESCRIPTION OF THE DRAWINGS

FIG. 1 is a schematic diagram of an image forming apparatus in which a charging device according to a first embodiment of the present invention is used;

FIG. 2 is a schematic diagram of an image forming unit in the first embodiment of the present invention;

FIG. 3 is a general view for explaining contact state of the charging device and a photoconductive drum in the first embodiment of the present invention;

FIG. 4 is a sectional view for explaining the contact state of the charging device and the photoconductive drum in the first embodiment of the present invention;

FIG. 5 is an enlarged sectional view of a main part of FIG. 4;

FIG. 6 is a sectional view for explaining a contact state of a charging device and a photoconductive drum in a second embodiment of the present invention;

FIG. 7 is an enlarged sectional view of a main part of FIG. 6;

FIG. 8 is a top view of a gap maintaining member in the second embodiment of the present invention; and

FIG. 9 is a sectional view for explaining a contact state of a charging device and a photoconductive drum in a third embodiment of the present invention.

### DETAILED DESCRIPTION

In general, according to one embodiment, a charging device includes a charging roller and gap maintaining members. The charging roller includes a conductive roller to which charging voltage is applied and a coating layer as a member for covering the outer circumferential surface of the conductive roller, ends of the coating layer being further extended by predetermined length along an extending direction of the conductive roller than end faces of the conductive roller. The charging roller charges, in a non-contact manner, a photoconductive drum arranged near the charging roller with the charging voltage applied via the conductive roller.

The gap maintaining members are respectively fixed at both ends of the charging roller in positions spaced apart from the ends of the charging roller. The gap maintaining members are set in contact with the photoconductive drum while keeping a predetermined charging gap between the coating layer and the photoconductive drum and rotate together with the charging roller according to the rotation of the photoconductive drum.

### First Embodiment

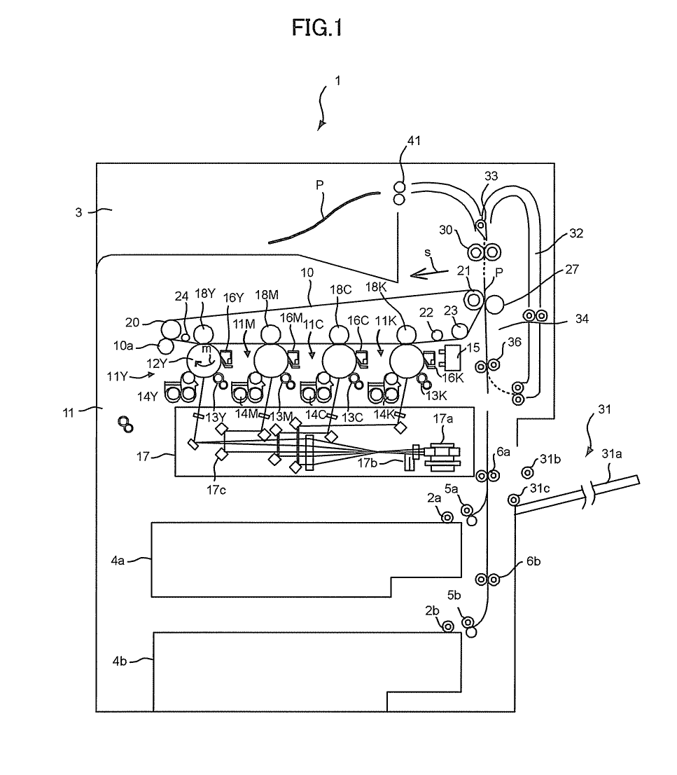

A first embodiment of the present invention is explained in detail below with reference to the accompanying drawings as examples. FIG. 1 is a schematic diagram of an image forming apparatus 1 in which a charging device according to the first embodiment of the present invention is used. As shown in the figure, the image forming apparatus 1 is a quadruple tandem type image forming apparatus. The image forming apparatus 1 includes a paper discharge unit 3 in an upper part thereof.

The image forming apparatus 1 includes an image forming unit 11 on the lower side of an intermediate transfer belt 10. The image forming unit 11 includes four image forming units 11Y, 11M, 11C, and 11K arranged in parallel along the intermediate transfer belt 10. The image forming units 11Y, 11M, 11C, and 11K respectively form toner images of yellow (Y), magenta (M), cyan (C), and black (K). A temperature and humidity sensor 15 as an environment detecting unit is provided near the image forming unit 11 of the image forming apparatus 1.

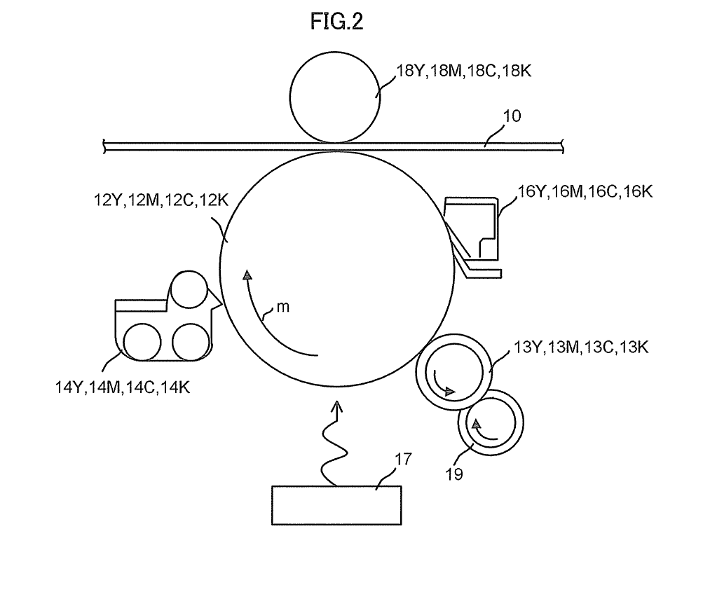

FIG. 2 is a schematic diagram of the image forming unit in the first embodiment of the present invention. As shown in FIG. 2, the image forming units 11Y, 11M, 11C, and 11K respectively include photoconductive drums 12Y, 12M, 12C, and 12K as image bearing members. The photoconductive drums 12Y, 12M, 12C, and 12K rotate in an arrow m direction. Charging devices 13Y, 13M, 13C, and 13K, developing devices 14Y, 14M, 14C, and 14K, and photoconductive member cleaner 16Y, 16M, 16C, and 16K are respectively arranged around the photoconductive drums 12Y, 12M, 12C, and 12K along the rotating direction.

The charging devices 13Y, 13M, 13C, and 13K perform charging when charging voltage is applied by a power supply (not shown) connected thereto and respectively rotate according to the rotation of the photoconductive drums 12Y, 12M, 12C, and 12K. The photoconductive drums 12Y, 12M, 12C, and 12K are uniformly charged in a non-contact manner. Cylindrical charging roller cleaners 19, which rotate reversely to charging rollers, are set in contact with the charging devices 13Y, 13M, 13C, and 13K. A toner and foreign matters such as dust adhering to the charging, rollers are removed by the charging roller cleaners 19. The charging roller cleaners 19 are formed of, for example, sponge.

Exposure lights emitted by a laser exposing device 17 are respectively irradiated on sections between the charging devices 13Y, 13M, 13C, and 13K and the developing devices 14Y, 14M, 14C, and 14K around the photoconductive drums 12Y, 12M, 12C, and 12K. The laser exposing device 17 scans the photoconductive drums 12Y, 12M, 12C, and 12K in an axis direction thereof with laser beams emitted from a semiconductor laser element. The laser exposing device 17 includes a polygon mirror 17a, an imaging lens system 17b, and a mirror 17c. Electrostatic latent images are formed on the photoconductive drums 12Y, 12M, 12C, and 12K by the laser exposing device 17.

The developing devices 14Y, 14M, 14C, and 14K develop the electrostatic latent images on the photoconductive drums 12Y, 12M, 12C, and 12K. The developing devices 14Y, 14M, 14C, and 14K perform development using two-component developers having toners of yellow (Y), magenta (M), cyan (C), and black (K) as developers and a carrier.

The intermediate transfer belt 10 is stretched and suspended by a backup roller 21, a driven roller 20, and first to third tension rollers 22 to 24 and rotated in an arrow s direction.

The intermediate transfer belt 10 are opposed to and set in contact with the photoconductive drums 12Y, 12M, 12C, and 12K. Primary transfer rollers 18Y, 18M, 18C, and 18K are provided in positions of the intermediate transfer belt 10 opposed to the photoconductive drums 12Y, 12M, 12C, and 12K. The primary transfer rollers 18Y, 18M, 18C, and 18K primarily transfer toner images formed on the photoconductive drums 12Y, 12M, 12C, and 12K onto the intermediate transfer belt 10. The photoconductive member cleaners 16Y, 16M, 16C, and 16K remove and collect residual toners on the photoconductive drums 12Y, 12M, 12C, and 12K after the primary transfer.

A secondary transfer roller 27 is opposed to a secondary transfer section supported by the backup roller 21 for the intermediate transfer belt 10. In the secondary transfer section, predetermined secondary transfer bias is applied to the backup roller 21. When sheet paper P passes between the intermediate transfer belt 10 and the secondary transfer roller 27, the toner images on the intermediate transfer belt 10 are secondarily transferred onto the sheet paper P. The sheet paper P is fed from paper feeding cassettes 4a and 4b or a manual feeding mechanism 31. After the secondary transfer ends, the intermediate transfer belt 10 is cleaned by a belt cleaner 10a.

Pickup rollers 2a and 2b, separating rollers 5a and 5b, conveying rollers 6a and 6b, and a registration roller pair 36 are provided in a section between the paper feeding cassettes 4a and 4b and the secondary transfer roller 27. A manual feed pickup roller 31b and a manual feed separating roller 31c are provided in a section between a manual feed tray 31a of the manual feeding mechanism 31 and the registration roller pair 36. A fixing device 30 is provided further downstream than the secondary transfer unit along the direction of a vertical conveying path 34. The fixing device 30 fixes the toner images, which are transferred onto the sheet paper P in the secondary transfer section, on the sheet paper P. A gate 33 for directing the sheet paper P in the direction of a paper discharge roller 41 or the direction of a re-conveying unit 32 is provided downstream of the fixing device 30. The sheet paper P led to the paper discharge roller 41 is discharged to the paper discharge unit 3. The sheet paper P led to the re-conveying unit 32 is led in the direction of the secondary transfer roller 27 again.

The charging devices 13Y, 13M, 13C, and 13K are explained in detail below. The charging devices 13Y, 13M, 13C, and 13K have the same structure. Similarly, the photoconductive drums 12Y, 12M, 12C, and 12K respectively corresponding to the charging devices have the same structure. Therefore, in the following explanation, a relation between a charging device 13 representing the charging devices 13Y, 13M, 13C, and 13K and a photoconductive drum 12 representing the photoconductive drums 12Y, 12M, 12C, and 12K is explained.

The charging device 13 is a member made of metal connected to a power supply (not shown) provided in the inside of the image forming apparatus 1. Charging voltage is applied to the charging device 13.

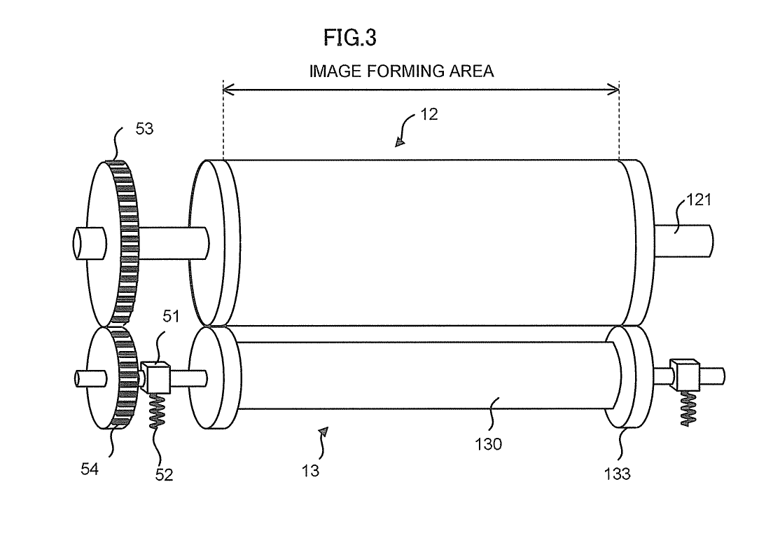

FIG. 3 is a general diagram for explaining a contact state of the charging device 13 and the photoconductive drum 12 in the first embodiment of the present invention. As shown in FIG. 3, in gap maintaining members 133 provided at both ends of a charging roller 130 of the charging device 13, the charging device 13 is set in contact with the photoconductive drum 12. On the outer circumferential surface in the center portion of the charging roller 130, a predetermined gap is maintained between the charging device 13 and an image forming area of the photoconductive drum 12.

In bearing members 51 of shaft sections formed to project in the axis direction from both end faces of a rotating shaft of the charging roller 130, the charging roller 130 is pressed in the direction of the photoconductive drum 12 with urging force of compression springs 52. A drum driving gear 53 for driving to rotate the photoconductive drum 12 is fixed on the left end side of a rotating shaft 121 of the photoconductive drum 12. Similarly, a charging roller driving gear 54 for driving to rotate the charging roller 130 is fixed on the left end side of the charging roller 130 of the charging device 13. When driving force of a motor (not shown) is transmitted to the drum driving gear 53, the photoconductive drum 12 is driven to rotate. When the driving force of the motor is transmitted to the charging roller gear 54 according to the rotation of the photoconductive drum 12, the charging roller 130 is driven to rotate and the photoconductive drum 12 is charged in a non-contact manner via the charging gap.

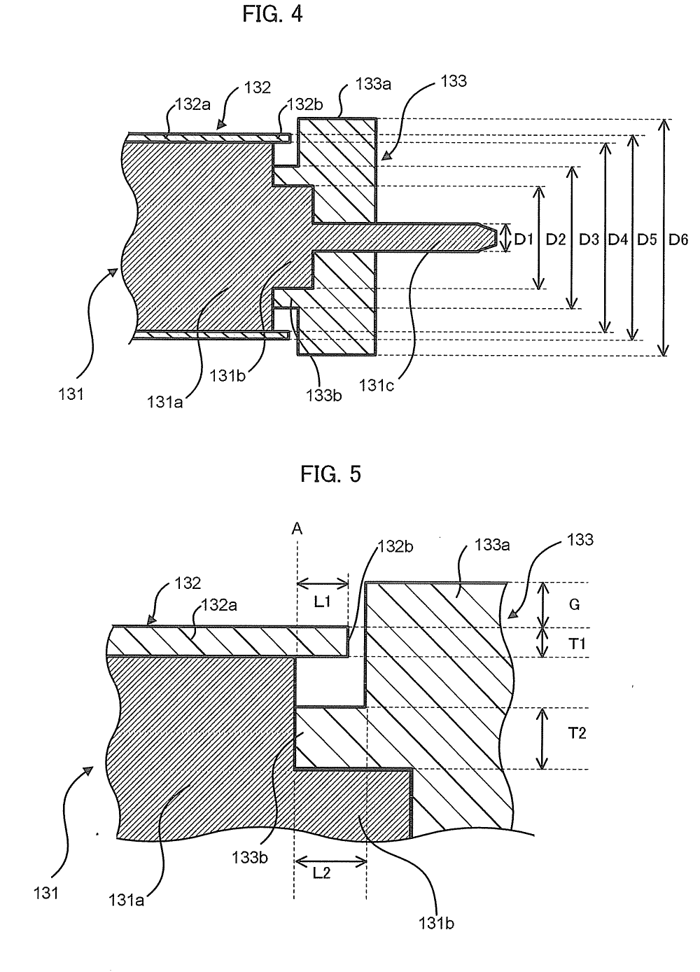

FIG. 4 is a sectional view for explaining the contact state of the charging device 13 and the photoconductive drum 12 in the first embodiment of the present invention. FIG. 5 is an enlarged sectional view of a main part of FIG. 4. As shown in FIGS. 4 and 5, the charging device 13 includes the charging roller 130 and the gap maintaining member 133. The charging roller 130 has a conductive roller 131 to which charging voltage is applied and a coating layer 132 as a member configured to cover the outer circumferential surface of the conductive roller 131. The conductive roller 131 configured to charge the photoconductive drum 12 in a non-contact manner with the charging voltage applied via the charging roller 131 includes a charging section 131a, a first rotating shaft section 131b, and a second rotating shaft section 131c. The charging section 131a is a charging area corresponding to the image forming area of the photoconductive drum 12. The first rotating shaft section 131b is an area formed to project from an end face of the charging section 131a at an outer diameter D3 smaller than an outer diameter D4 of the charging section 131a. The second rotating shaft section 131c is an area formed to project from a distal end of the first rotating shaft section 131b at an outer diameter D1 smaller than an outer diameter D2 of the first rotating shaft section 131b.

The coating layer 132 is a conductive member configured to cover the outer circumferential surface of the charging section 131a of the conductive roller 131 and is formed in, for example, a tube shape. The coating layer 132 includes a charging corresponding section 132a and an extended section 132b. The charging corresponding section 132a is an area that covers the outer circumferential surface of the charging section 131a.

The extended section 132b is an area obtained by further extending an end of the coating layer 132 by predetermined length L1 along an extending direction of the conductive roller 131 than the end face of the charging section 131a.

It is desirable that a material of the coating layer 132 is resin having volume resistivity equal to or higher than, for example, about 10⁶Ω·cm because, if the volume resistivity is too low, voltage concentration (a leak) on the photoconductive drum 12 and abnormal discharge are caused. However, if the volume resistivity is too high, sufficient charging potential for obtaining a uniform image cannot be obtained because of insufficiency of a charging amount. Therefore, it is desirable that the material of the coating layer 132 is a material having volume resistivity equal to or lower than, for example, about 10¹²Ω·cm. Therefore, for example, it is desirable to use, for example, thermoplastic resin containing carbon and polyether ester amide as a conductive material. It is also possible to use a material obtained by formulating insulative thermoplastic resin and conductive resin at a predetermined ratio.

Thickness T1 of the coating layer 132 is set such that an outer diameter D5 of the charging section 131a of the conductive roller 131 covered with the coating layer 132 is smaller than an outer diameter D6 in a contact section of the gap maintaining member 133. In some case, if the thickness T1 of the coating layer 132 is too small, abnormal discharge due to a leak occurs or a crack tends to occur. Therefore, it is desirable to set the thickness T1 of the coating layer 132 to thickness equal to or larger than, for example, about 50 μm. However, if the thickness T1 of the coating layer 132 is too large, it is difficult to charge the conductive drum 12 because of the influence of resistance. Therefore, it is desirable to set the thickness T1 of the coating layer 132 to thickness equal to or smaller than, for example, about 200 μm.

The length L1 of the extended section 132b is set smaller than length L2 of projection of the gap maintaining member 133 such that a tube end does not come into contact with the end face of the gap maintaining member 133. If the length L1 of the extended section 132b is too short, it is likely that abnormal discharge occurs. Therefore, it is desirable to set the length L1 of the extended section 132b to length equal to or larger than, for example, about 0.5 mm. However, if the length L1 of the extended section 132b is too large, the apparatus is increased in size. Therefore, it is desirable to set the length L1 of the extended section 132b to length equal to or smaller than about 2 mm.

The gap maintaining member 133 is a member set in contact with the photoconductive drum 12 while keeping a predetermined very small charging gap G between the coating layer 132 and the photoconductive drum 12 and configured to rotate together with the conductive roller 131 according to the rotation of the photoconductive drum 12. The gap maintaining member 133 is fixed to the first rotating shaft section 131b and the second rotating shaft section 131c in positions away from the end of the coating layer 132.

A material of the gap maintaining member 133 is required to be robust against abrasion when it is taken into account that the gap maintaining member 133 is set in contact with the photoconductive drum 12 while being pressed against the photoconductive drum 12. Therefore, it is desirable to use thermoplastic resin such as polyacetal, polyamide, polycarbonate, ABS resin, or acryl resin.

The gap maintaining member 133 has a contact section 133a and a projecting section 133b. The contact section 133a indicates an area of a ring shape set in contact with the photoconductive drum 12 on the outer circumferential surface thereof. The projecting section 133b indicates an area set in contact with the charging section 131a while projecting from an end face of the contact section 133a at the outer diameter D3 smaller than the outer diameter D4 of the charging section 131a. An inner diameter of the projecting section 133b coincides with an outer diameter of the first rotating shaft section 131b of the conductive roller 131 and is formed in a shape in which the first rotating shaft section 131b can be fit.

Specifically, the gap between the conductive roller 131 and the photoconductive drum 12 is maintained by a method explained below. First, the outer circumferential surface of the charging area (the charging section 131a) of the conductive roller 131, to which the charging voltage is applied, is covered with the conductive coating layer 132 formed longer than the length in a longitudinal direction of the charging area (the charging section 131a). The ends of the coating layer 132 are further extended by predetermined length along the extending direction of the conductive roller 131 than the end faces of the conductive roller 131 to form the extended sections 132b. For example, after the charging section 131a of the conductive roller 131 is covered with the coating layer 132, the coating layer 132 only has to be cut rather long in order to form the extended sections 132b.

Next, the gap maintaining members 133 for maintaining the predetermined charging gap between the coating layer 132 and the photoconductive drum 12 are respectively fixed to both ends (the first rotating shaft sections 131b and the second rotating shaft sections 131c) of the conductive roller 131 in positions spaced apart from the ends (the extended sections 132b) of the coating layer 132.

The gap maintaining members 133 provided at both the ends of the conductive roller 131 are set in contact with the outer circumferential surface of the photoconductive drum 12. The image forming area of the photoconductive drum 12 and the charging area (the charging corresponding section 132a) of the coating layer 132 are arranged to be opposed to each other.

According to the first embodiment, during image formation, when the charging voltage is applied to the conductive roller 131 from a connected power supply (not shown) via the compression springs 52 fixed to the second rotating shaft sections 131c, the charging voltage is also uniformly applied to the charging section 131a and the first rotating shaft sections 131b. When the charging section 131a is charged, the conductive coating layer 132 that covers the charging section 131a is also charged. In other words, the charging corresponding section 132a opposed to the image forming area of the photoconductive drum 12 is charged. Further, the extended sections 132b extended from the charging corresponding section 132a by the predetermined length L1 are also uniformly charged. When the charging corresponding section 132a and the extended sections 132b are charged, since the outer circumferential surface of the charging section 131a of the conductive roller 131 is uniformly covered by the charging corresponding section 132a of the coating layer 132 entirely, charging potential of the charging is uniform.

Unlike the past, it is unnecessary to set the length of the coating layer 132 and the length of the end of the charging section 131a of the conductive roller 131 the same at high accuracy. In other words, it is possible to uniformly charge the charging corresponding section 132a of the coating layer 132 entirely to the end.

Further, it is possible to prevent a projection and a recess from being caused by bending of the end of the coating layer 132. Therefore, it is possible to prevent abnormal discharge and a leak caused by the projection and the recess.

### Second Embodiment

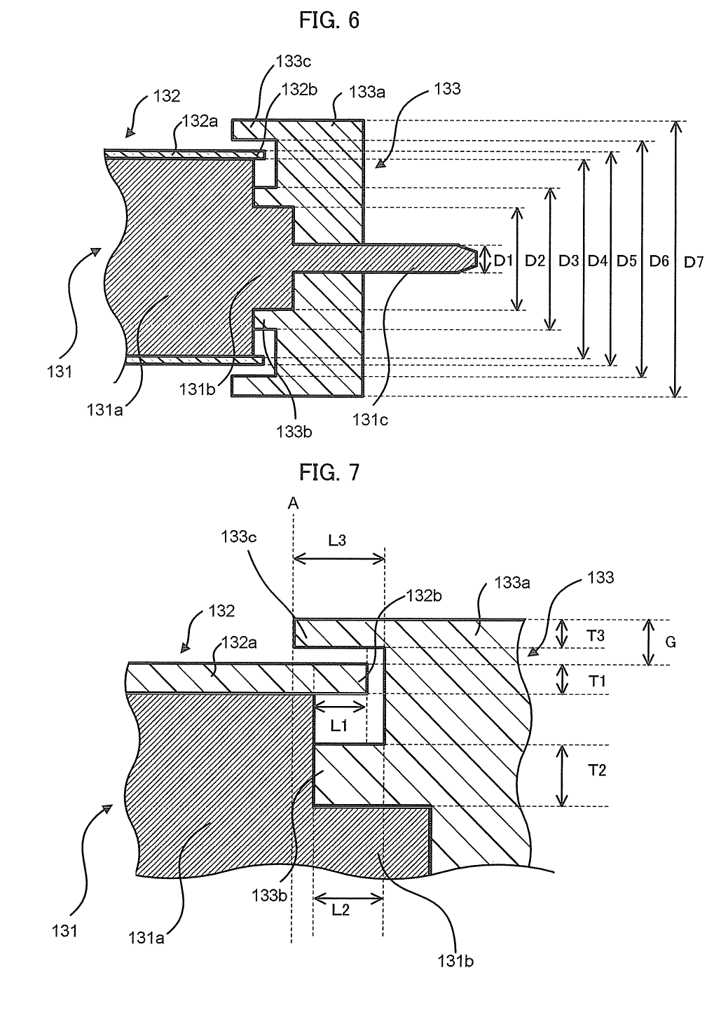

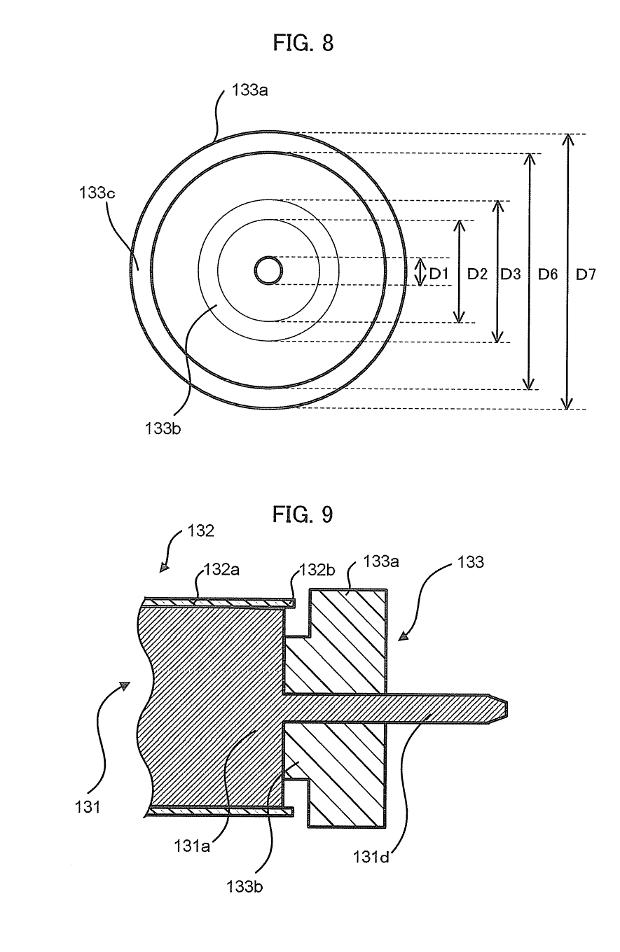

A second embodiment of the present invention is explained below with reference to FIGS. 6 to 8. FIG. 6 is a sectional view for explaining a contact state of a charging device 13 and the photoconductive drum 12 in the second embodiment of the present invention. FIG. 7 is an enlarged sectional view of a main part of FIG. 6. FIG. 8 is a top view of a gap maintaining member 133 in the second embodiment of the present invention. The second embodiment is different from the first embodiment in the shape of the gap maintaining member 133. Otherwise, the second embodiment is the same as the first embodiment. Therefore, components same as those explained in the first embodiment are denoted by the same reference numerals and signs and detailed explanation of the components is omitted.

In this embodiment, as shown in FIGS. 6 to 8, the gap maintaining member 133 has a contact section 133a, a first projecting section 133b, and a second projecting section 133c. The contact section 133a is an area of a ring shape set in contact with the photoconductive drum 12 on the outer circumferential surface thereof.

The first projecting section 133b is an area set in contact with the charging section 131a on an end face thereof while projecting from the end face of the contact section 133a at the outer diameter D3 smaller than the outer diameter D4 of the charging section 131a. Since the first projecting section 133b projects, the charging section 131a of the conductive roller 131 and the contact section 133a of the gap maintaining member 133 are fixed in a surely separated state.

The second projecting section 133c is an area that projects, in a ring shape, from an end face same as that of the first projecting section 133b to a section between the end of the charging corresponding section 132a and the photoconductive drum 12 at an inner diameter D6 larger than the outer diameter D5 of the coating layer 132. Thickness T3 of the second projecting section 133c can be arbitrarily changed taking into account the strength of the gap maintaining member 133.

In FIG. 7, the second projecting section 133c is also set in contact with the photoconductive drum 12 in the same manner as the contact section 133a. However, the second projecting section 133c only has to project into a space on the outer circumference of the extended section 132b. In other words, the second projecting section 133c may be formed to project from a position closer to the rotating shaft of the conductive roller 131 than a contact surface of the contact section 133a and not in contact with the conductive drum 12.

Length L3 of projection of the second projecting section 133c from the end face of the contact section 133a is set longer than the length L2 of projection of the first projecting section 133b from the end face of the contact section 133a. The image forming area of the photoconductive drum 12 is set further on the center side of the conductive roller 131 than a boundary surface A.

According to the second embodiment, compared with the first embodiment, it is possible to protect, with the gap maintaining member 133, the end of the coating layer 132 from an apart position of the outer circumference and charge the photoconductive drum 12.

Therefore, there is an advantage that, even if abnormal discharge or a leak occurs at the end of the conductive roller 131, it is possible to uniformly charge the image forming area of the photoconductive drum 12 opposed to the charging corresponding section 132a.

### Third Embodiment

A third embodiment of the present invention is explained below. The third embodiment is different from the first embodiment in a shape of a conductive roller 131. Otherwise, the third embodiment is the same as the first embodiment. Therefore, components same as those explained in the first embodiment are denoted by the same reference numerals and signs and detailed explanation of the components is omitted.

FIG. 9 is a sectional view for explaining a contact state of the charging device 13 and the photoconductive drum 12 in the third embodiment of the present invention. In this embodiment, as shown in FIG. 9, compared with the first embodiment, the second rotating shaft section 131b is omitted from the conductive roller 131. The conductive roller 131 is formed by only a charging section 131a and a rotating shaft section 131d formed to project from the end face of the charging section 131a at an outer diameter smaller than the outer diameter of the charging section 131a.

As a shape of a gap maintaining member 133, a through hole conforming to the shape of the rotating shaft section 131d is formed in the center portion of the gap maintaining member 133.

According to the third embodiment, since the shape of the conductive roller 131 is simplified, the shape of the gap maintaining member 133 fixed to the rotating shaft section 131d of the conductive roller 131 is also simplified.

Therefore, there is an advantage that the conductive roller 131 and the gap maintaining member 133 are easily manufactured compared with the first and second embodiments.

While certain embodiments have been described, these embodiments have been presented by way of example only, and are not intended to limit the scope of the inventions. Indeed, the novel apparatus and methods described herein may be embodied in a variety of other forms: furthermore various omissions, substitutions and changes in the form of the apparatus and methods described herein may be made without departing from the spirit of the inventions. The accompanying claims and their equivalents are intended to cover such forms of modifications as would fall within the scope and spirit of the invention.

What is claimed is:

1. A charging device comprising:
a charging roller including a conductive roller to which charging voltage is applied and a coating layer as a member for covering an outer circumferential surface of the conductive roller, ends of the coating layer being further extended by predetermined length along an extending direction of the conductive roller than end faces of the conductive roller, and the charging roller charging, in a non-contact manner, a photoconductive drum arranged near the charging roller with the charging voltage applied via the conductive roller; and
gap maintaining members respectively fixed at both ends of the charging roller in positions spaced apart from the ends of the charging roller, the gap maintaining members being, while keeping a predetermined charging gap between the coating layer and the photoconductive drum, set in contact with the photoconductive drum and rotating together with the charging roller according to rotation of the photoconductive drum.

2. A charging device comprising:
a charging roller including: a conductive roller including a charging section corresponding to an image forming area of a photoconductive drum and rotating shaft sections formed to project from end faces of the charging section, charging voltage being applied to the conductive roller; and a coating layer including a charging corresponding section configured to cover an outer circumferential surface of the charging section and extended sections formed by further extending ends of the coating layer by predetermined length along an extending direction of the conductive roller than the end faces of the charging section, the charging roller charging, in a non-contact manner, the photoconductive drum with the charging voltage applied via the conductive roller; and
gap maintaining members including: contact sections set in contact with the photoconductive drum on outer circumferential surfaces thereof; and projecting sections projecting from end faces of the contact sections at an outer diameter smaller than an outer diameter of the charging section and set in contact with the charging section, the gap maintaining members being respectively fixed to the rotating shaft sections in positions spaced apart from the ends of the coating layer, set in contact with the photoconductive drum while keeping a predetermined charging gap between the coating layer and the photoconductive drum, and rotating together with the charging roller according to rotation of the photoconductive drum.

3. The device according to claim 2, wherein a material of the coating layer is resin having volume resistivity equal to or higher than about 10⁶Ω·cm and equal to or lower than about 10¹²Ω·cm.

4. The device according to claim 2, wherein a material of the gap maintaining members is thermoplastic resin.

5. The device according to claim 2, wherein length of the extended sections is equal to or larger than about 0.5 mm and equal to or smaller than about 2 mm.

6. The device according to claim 2, wherein thickness of the coating layer is equal to or larger than about 50 μm and equal to or smaller than about 200 μm.

7. A charging device comprising:
a charging roller including: a conductive roller including a charging section corresponding to an image forming area of a photoconductive drum and rotating shaft sections formed to project from end faces of the charging section at an outer diameter smaller than an outer diameter of the charging section, charging voltage being applied to the conductive roller; and a coating layer including a charging corresponding section configured to cover an outer circumferential surface of the charging section and extended sections formed by further extending ends of the coating layer by predetermined length along an extending direction of the conductive roller than the end faces of the charging section, the charging roller charging, in a non-contact manner, the photoconductive drum with the charging voltage applied via the conductive roller; and
gap maintaining members including: contact sections set in contact with the photoconductive drum on outer circumferential surfaces thereof; first projecting sections projecting from end faces of the contact sections at an outer diameter smaller than the outer diameter of the charging section and set in contact with the charging section; and second projecting sections projecting, in a ring shape, from the same end faces to sections between ends of the charging corresponding sections and the photoconductive drum at an inner diameter larger than an outer diameter of the coating layer, the gap maintaining members being respectively fixed to the rotating shaft sections in positions spaced apart from the ends of the coating layer, set in contact with the photoconductive drum while keeping a predetermined charging gap between the coating layer and the photoconductive drum, and rotating together with the charging roller according to rotation of the photoconductive drum.

8. The device according to claim 7, wherein a material of the coating layer is resin having volume resistivity equal to or higher than about 10⁶Ω·cm and equal to or lower than about 10¹²Ω·cm.

9. The device according to claim 7, wherein a material of the gap maintaining members is thermoplastic resin.

10. The device according to claim 7, wherein length of the extended sections is equal to or larger than about 0.5 mm and equal to or smaller than about 2 mm.

11. The device according to claim 7, wherein thickness of the coating layer is equal to or larger than about 50 μm and equal to or smaller than about 200 μm.

12. A charging device comprising:
a charging roller including: a conductive roller including a charging section corresponding to an image forming area of a photoconductive drum, first rotating shaft sections projecting from end faces of the charging section at an outer diameter smaller than an outer diameter of the charging section, and second rotating shaft sections projecting from distal ends of the first rotating shaft sections at an outer diameter smaller than the outer diameter of the first rotating shaft sections, charging voltage being applied to the conductive roller; and a coating layer including a charging corresponding section configured to cover an outer circumferential surface of the charging section and extended sections formed by further extending ends of the coating layer by predetermined length along an extending direction of the conductive roller than the end faces of the charging section, the charging roller charging, in a non-contact manner, the photoconductive drum with the charging voltage applied via the conductive roller; and
gap maintaining members including: contact sections set in contact with the photoconductive drum on outer circumferential surfaces thereof; and projecting sections projecting from end faces of the contact sections at an outer diameter smaller than an outer diameter of the charging section and set in contact with the charging section, the gap maintaining members being respectively fixed to the first and second rotating shaft sections in positions spaced apart from the ends of the coating layer, set in contact with the photoconductive drum while keeping a predetermined charging gap between the coating layer and the photoconductive drum, and rotating together with the charging roller according to rotation of the photoconductive drum.

13. The device according to claim 12, wherein a material of the coating layer is thermoplastic resin having volume resistivity equal to or higher than about 10⁶Ω·cm and equal to or lower than about 10¹²Ω·cm.

14. The device according to claim 13, wherein length of the extended sections is equal to or larger than about 0.5 mm and equal to or smaller than about 2 mm.

15. The device according to claim 14, wherein thickness of the coating layer is equal to or larger than about 50 μm and equal to or smaller than about 200 μm.

16. A charging device comprising:
a charging roller including: a conductive roller including a charging section corresponding to an image forming area of a photoconductive drum, first rotating shaft sections projecting from end faces of the charging section at an outer diameter smaller than an outer diameter of the charging section, and second rotating shaft sections projecting from distal ends of the first rotating shaft sections at an outer diameter smaller than the outer diameter of the first rotating shaft sections, charging voltage being applied to the conductive roller; and a coating layer including a charging corresponding section configured to cover an outer circumferential surface of the charging section and extended sections formed by further extending ends of the coating layer by predetermined length along an extending direction of the conductive roller than the end faces of the charging section, the charging roller charging, in a non-contact manner, the photoconductive drum with the charging voltage applied via the conductive roller; and
gap maintaining members including: contact sections set in contact with the photoconductive drum on outer circumferential surfaces thereof; first projecting sections projecting from end faces of the contact sections at an outer diameter smaller than the outer diameter of the charging section and set in contact with the charging section; and second projecting sections projecting, in a ring shape, from the same end faces to sections between ends of the charging corresponding sections and the photoconductive drum at an inner diameter larger than an outer diameter of the coating layer, the gap maintaining members being respectively fixed to the rotating shaft sections in positions spaced apart from the ends of the coating layer, set in contact with the photoconductive drum while keeping a predetermined charging gap between the coating layer and the photoconductive drum, and rotating together with the charging roller according to rotation of the photoconductive drum.

17. The device according to claim 16, wherein a material of the coating layer is thermoplastic resin having volume resistivity equal to or higher than about 10⁶Ω·cm and equal to or lower than about 10¹²Ω·cm and the coating layer has thickness equal to or larger than about 50 μm and equal to or smaller than about 200 μm.

18. The device according to claim 17, wherein length of the extended sections is equal to or larger than about 0.5 mm and equal to or smaller than about 2 mm.

19. An image forming apparatus comprising:
a photoconductive drum on which an electrostatic latent image and a toner image are formed;
a charging device arranged near the photoconductive drum and configured to charge the photoconductive drum in a non-contact manner;
an exposing device configured to expose an image forming area of the photoconductive drum to light and write the electrostatic latent image;
a developing device configured to develop, with a developer, the electrostatic latent image formed on the photoconductive drum and form the toner image on a surface of the photoconductive drum; and
a transfer device configured to transfer the toner image formed on the photoconductive drum onto a recording medium, wherein
the charging device including:
a charging roller including a conductive roller to which charging voltage is applied and a coating layer as a member for covering an outer circumferential surface of the conductive roller, ends of the coating layer being further extended by predetermined length along an extending direction of the conductive roller than end faces of the conductive roller, and the charging roller charging, in a non-contact manner, the photoconductive drum arranged near the charging roller with the charging voltage applied via the conductive roller; and
gap maintaining members respectively fixed at both ends of the charging roller in positions spaced apart from the ends of the charging roller, the gap maintaining members being, while keeping a predetermined charging gap between the coating layer and the photoconductive drum, set in contact with the photoconductive drum and rotating together with the charging roller according to rotation of the photoconductive drum.

20. A method of maintaining a gap between a charging roller and a photoconductive drum, the method comprising:
covering an outer circumferential surface of a charging area of a conductive roller, to which charging voltage is applied, with a conductive coating layer formed longer than length in a longitudinal direction of the charging area and forming extended sections obtained by further extending ends of the coating layer by predetermined length along an extending direction of the conductive roller than end faces of the conductive roller;
respectively fixing gap maintaining members for keeping a predetermined charging gap between the coating layer and the photoconductive drum to both ends of the charging roller in positions spaced apart from the ends of the coating layer; and
setting the gap maintaining members in contact with the photoconductive drum and arranging an image forming area of the photoconductive drum and a charging area of the coating layer to be opposed to each other.
